(19) United States
(12) Patent Application Publication
(10) Pub. No.: US 2005/0143097 A1
(43) Pub. Date: Jun. 30, 2005

(54) System for providing location-based services in a wireless network, such as providing notification regarding meetings, destination arrivals, and the like

(75) Inventors: Brian Wilson, Bellevue, WA (US); Krishna Bhuyan, Redmond, WA (US); Jacob Feinstein, Seattle, WA (US); Jerald J. Gnuschke, Redmond, WA (US)

Correspondence Address: PERKINS COIE LLP/AWS, P.O. BOX 1247, SEATTLE, WA, 98111-1247, US

(73) Assignee: Cingular Wireless II, LLC

(21) Appl. No.: 11/065,971

(22) Filed: Feb. 24, 2005

Related U.S. Application Data
(63) Continuation-in-part of application No. 10/324,984, filed on Dec. 20, 2002.
(60) Provisional application No. 60/388,944, filed on Jun. 14, 2002.
(60) Provisional application No. 60/388,942, filed on Jun. 14, 2002.

(51) Int. Cl. H04Q 7/20

(52) U.S. Cl. 455/456.3; 455/456.1

(57) ABSTRACT

A system obtains a request from a subscriber associated with a first mobile device or notification when at least one person associated with a second mobile device arrives at or near a predetermined location. The system automatically determines a location of at least the second mobile device and provides a notification message to the first mobile device when the second mobile device is at or near the predetermined location. The system can also provide the notification message to another telecommunications or computing device coupled to the network and specified by the subscriber.

### CROSS-REFERENCE TO RELATED APPLICATION(S)

This application is a continuation-in-part of U.S. patent application Ser. No. 10/324,984, filed Dec. 20, 2002 (attorney docket no. 10194.8094.US2), which claims priority to U.S. Patent Application Nos. 60/388,944, and 60/388,942, both filed Jun. 14, 2002.

### BACKGROUND

“Where am I?” “Where are you?” “Where is it?” are questions often asked, but not always easily answered. Global positioning system (GPS) and similar location determining devices have allowed users to locate themselves on our planet. Together with mapping software, the GPS network allows users to identify themselves with respect landmarks, streets, and the like. These and other location determining systems have been used with vehicles (often referred to as “telematics”).

Such telematic systems help users identify where their vehicles are with respect to an electronic map to determine directions to a location. A user can input a destination on such telematic systems, and mapping software (often stored in the vehicle with a database of maps) helps determine an appropriate route for the vehicle using an associated GPS device. The mapping software and associated maps may include lists of addresses or points of interest (PO's) to which the system may compute a route.

Fleet tracking systems or automatic vehicle location (AVL) systems allow a central location to track the locations of various vehicles in a fleet, where each vehicle includes an onboard system having wireless circuitry to provide the position of a vehicle in the fleet to the central location. Examples of such systems are provided by, for example, Qualcomm of San Diego, Calif.

Certain services, such as Maps.com, allow users to access a large database of maps and request directions or routes from a starting point to an ending point. If a user has a wireless, Internet-enabled device, such as a wireless palmtop computer, the user may then access such maps and associated directions wirelessly. Still, there is a need for improved location-based services and systems.

### BRIEF DESCRIPTION OF THE DRAWINGS

FIG. 1 is a block diagram of a suitable system for employing location-based services under embodiments of the invention.

FIG. 2 is a flow diagram illustrating a process for providing a user with notification when participants arrive at a meeting.

FIG. 3 is a flow diagram illustrating an alternative to the process of FIG. 2.

FIG. 4 is a block diagram of a suitable mobile device.

The headings provided herein are for convenience only and do not necessarily affect the scope or meaning of the claimed invention.

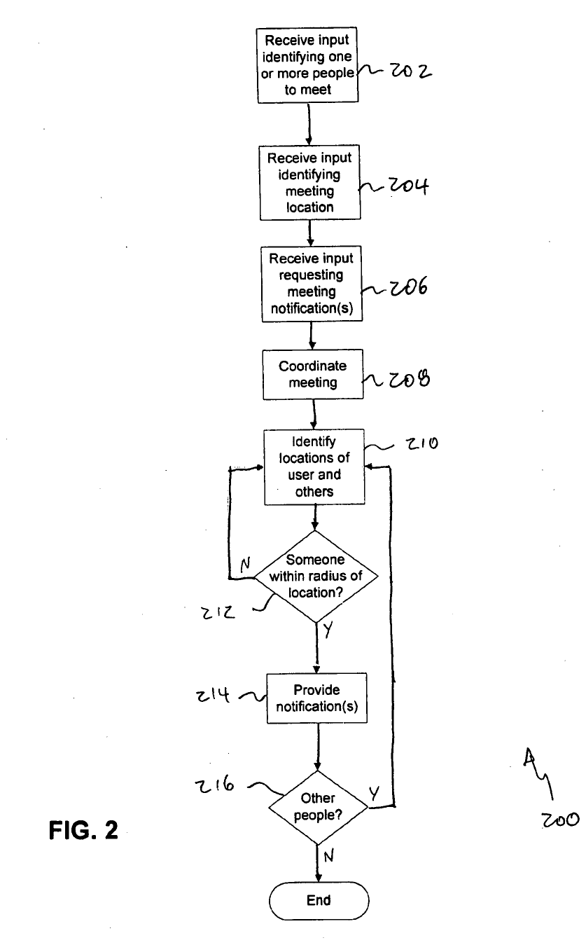

In the drawings, the same reference numbers identify identical or substantially similar elements or acts. To easily identify the discussion of any particular element or act, the most significant digit or digits in a reference number refer to the Figure number in which that element is first introduced (e.g., block 202 is first introduced and discussed with respect to FIG. 2).

### DETAILED DESCRIPTION

Described in detail below is a system and associated method that allows users to identify and notify one or more people about a meeting, identify a location, receive information regarding the meeting (e.g., receiving directions), and receive one or more notifications of when these people arrive at the identified location, all via a central system that coordinates the meeting, including RSVPs, arrival notifications, and other messages.

The system uses location services, such as GPS or wireless network service information, to determine mobile device locations, searches a database of Points of Interest (POIs) or geographic locations, and coordinates meetings or otherwise provides information to the user. For example, the user may be notified when a predetermined person approaches a predetermined location. Various other features are described in detail herein.

In a broad sense, embodiments of the invention relate to location-based services in a system for providing wireless telecommunications services to mobile devices. The method under this system obtains a request from a subscriber associated with a first mobile device or notification when at least one person associated with a second mobile device arrives near a predetermined location. The system automatically determines a location of at least the second mobile device and provides a notification message to the first mobile device when the second mobile device is near the predetermined location. The system can also provide the notification message to another telecommunications or computing device coupled to the network and specified by the subscriber.

The invention will now be described with respect to various embodiments. The following description provides specific details for a thorough understanding of, and enabling description for, these embodiments of the invention. However, one skilled in the art will understand that the invention may be practiced without these details. In other instances, well-known structures and functions have not been shown or described in detail to avoid unnecessarily obscuring the description of the embodiments of the invention.

The terminology used in the description presented below is intended to be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this Detailed Description section.

A representative system to implement functionality described herein will first be described. Thereafter, representative location-based functionality is described. Finally, suitable mobile devices and alternatives are described.

Representative System

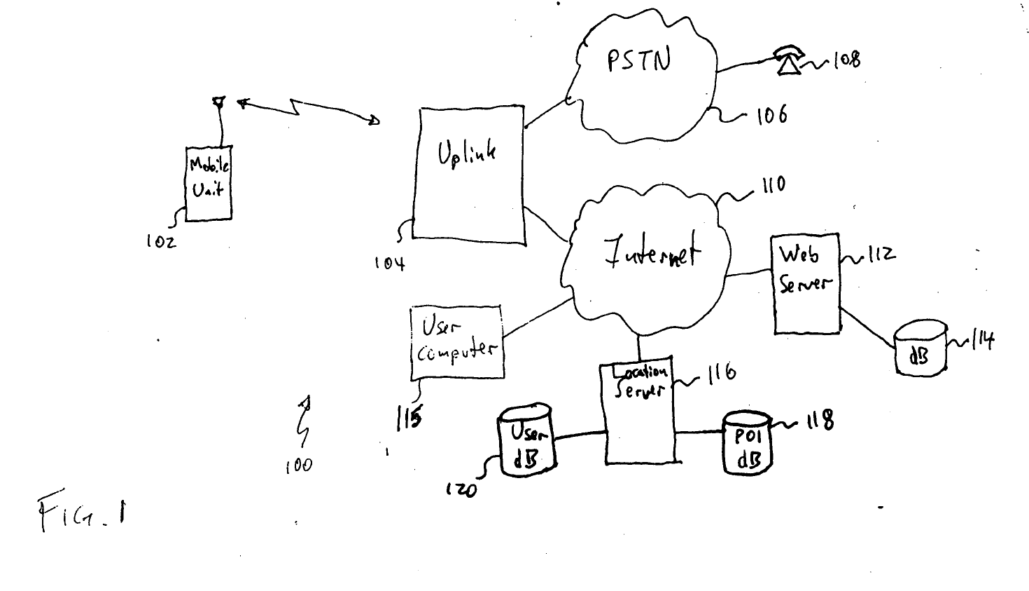

Referring to FIG. 1, a system 100 is shown where a wireless device or mobile unit 102 (such as a 2.5 G GPRS-enabled mobile handset) communicates wirelessly to a 2.5 G uplink 104. A typical 2.5 G uplink 104 includes multiple components not shown, such as (in order), a base transceiver station (BTS), a base station controller (BSC), and in a General Packet Radio Service (GPRS), a Gateway Serving GPRS Support Node (SGSN), a GPRS wide area network (WAN), a Gateway GPRS Support Node (GGSN), a wireless access protocol (WAP) gateway, and other components known by those skilled in the relevant art. Further details regarding a suitable system for implementing functionality described herein may be found in commonly assigned U.S. patent application Ser. No. 10/324,984, entitled, “System For Providing Location-Based Services In A Wireless Network, Such As Locating Individuals And Coordinating Meetings” (Attorney Docket No. 10194.8094.US2). Of course, while a 2.5 G network and wireless device are shown, embodiments of the invention may be used in various other wireless systems such as, but not limited to, Code Division Multiple Access (CDMA), Wide-band CDMA (WCDMA), CDMA-2000, IS-95 CDMA, IS-136 Time Division Multiple Access (IS-136 TDMA), IEEE802.11 Wireless Local Area Network (802.11), and Bluetooth.

Through the uplink 104 and public switched telephone network 106 the mobile unit 102 may communicate with a landline phone 108, using known means. Likewise, the mobile unit can access a data network, such as the Internet 110 to access content provided by a web server 112 from a database 114. The mobile unit 102 can also provide messages to, or receives messages from, any computer, such as a user computer 115, which is shown connected to the Internet 110. While two separate networks 106 and 110 are shown, a single network may be provided, or more than two networks provided to the mobile unit 102. Further, the mobile unit 102 may access numerous other services and systems via the system 100.

A location server 116 provides much of the functionality described below. While shown as a single computer, the location server 116 may in fact be two or more computers or data processing platforms configured to provide the functionality described herein. The location server 116 communicates with a location database 110 that provides information regarding points of interest, maps, and the like. Likewise, the location server 116 communicates with a user database 120 that stores tables or data structures regarding user preferences, and other user-specific data, often logically linked to the user's mobile unit 102.

While a mobile unit or phone is shown in FIG. 1, those skilled in the relevant art will appreciate that the invention can be practiced with other devices and configurations, including Internet appliances, hand-held devices, wearable computers, multi-processor systems, microprocessor-based or programmable consumer electronics, set-top boxes, network PCs, mini-computers, mainframe computers and the like. The invention can be embodied in a special purpose computer or data processor that is specifically programmed, configured or constructed to perform one or more of the computer-executable instructions explained in detail below. Indeed, the terms “computer,” “telecommunications device,” and “wireless device,” as used generally herein, refers to any of the above devices and systems, as well as any data processor.

The system 100 performs a routine, described below, that permits a user or subscriber to establish a meeting at one or more locations, or define a destination for another person, and receive one or more notification messages regarding such. The routine is described below as being executed by the location server 116 (or related components), which provides display pages or menus to the mobile unit 102, although much of the functionality could be moved to the mobile unit. (The terms “mobile unit,” “mobile device,” and similar terms, are often used interchangeably herein.) The routine that may be implemented as computer-executable instructions, such as routines executed by a general-purpose computer (e.g., a server or personal computer). Such instructions may be stored or distributed on computer-readable media, including magnetic and optically readable and removable computer disks, hard-wired or preprogrammed in chips (e.g., EEPROM semiconductor chips or ASICs), as well as distributed electronically over the Internet or over other networks (including wireless networks). Those skilled in the relevant art will recognize that portions of some embodiments of the invention may reside on a server computer, while corresponding portions may reside on a client computer or wireless device. Data structures and transmission of data particular to aspects of the invention are also encompassed within the scope of the invention. In general, while specific hardware platforms, such as the system 100, are described herein, aspects of the invention are equally applicable to nodes on a network having corresponding resource locators or electronic addresses to identify such nodes for data routing and requesting execution of commands

The terms “user” and “subscriber” are used interchangeably, and refer to a given individual employing or otherwise affected by functionality or systems described herein. A “subscriber” need not necessarily be one who subscribes to the location-based services described herein. With respect to system functionality, the terms “user,” “subscriber,” and the like are logically equivalent, and represent any data that the system uses to identify and manage wireless devices and provide location information. The invention may be used for providing location-based services with respect to one or more wireless devices in a group or nodes in any network.

Suitable Process Flows

Referring to FIG. 2, a routine 200 is shown that illustrates a suitable process for providing a subscriber with one or more notifications when one or more meeting participants or invitees arrive at or near a meeting location. Beginning in block 202, the location server 116 receives input from the subscriber identifying one or more people that the subscriber wishes to meet. The subscriber may provide this input via his or her mobile unit 102. Alternatively, the subscriber may provide this input via, for example, the user computer 115, the land line phone 108, or other telecommunications devices coupled to the PSTN 106, Internet 110, or both.

The subscriber may identify the invitees based on a previously stored user list of individuals, such as individuals stored in memory of the mobile unit 102, or stored in the user database 120 and retrieved by the mobile device, e.g., based on an appropriate user query of a list previously stored by the subscriber. Alternatively, the subscriber may conduct a query of one or more databases to identify electronic addresses, such as phone numbers, email addresses, instant messaging handles, etc. For example, the subscriber may conduct a query of an employee database associated with the subscriber's employer to identify invitees for a meeting.

In block 204, the location server 116 receives input identifying a meeting location. Again, the user identifies the meeting location via the mobile unit 102 or by other means as described above. The user may input the meeting location, or select a particular location from a list of POIs provided to the subscriber by the location server 116. For example, after identifying a person to meet, the system may provide a meeting place or POI category list. The list may include categories such as restaurants, coffee shops, bars/pubs, bookstores, etc. Other examples of points of interest include: parks, theaters, athletic facilities, etc., or even specialty locations such as pharmacies, hospitals, fire/police department locations, and other emergency-type locations. (In general, a point of interest may be any physical or geographic location.) The system may provide a list of most common types of meeting places, as described herein. The meeting places may be associated with a location or location context. The location context need not be an exact street location, but a general area, such as city, neighborhood, site (e.g., cell site).

Alternatively, the location server may suggest meeting locations based on input provided by the subscriber. For example, under block 202 the server queries the database 120 to look up all previously user-identified individuals, and provide back to the user a display page containing a list of these individuals. Then, under block 204, the server may provide the last identified locations for meeting these individuals. The location server may provide options for a meeting, such as meeting near the subscriber, meeting near one of the invitees, meeting at a midpoint between the subscriber and the invitee, or even at an approximate equidistant midpoint between the subscriber and two or more invitees. Overall, details regarding identifying people to meet, and meeting locations are found in the U.S. patent application Ser. No. 10/324,984 noted above (“the above application”).

In block 206, the location server 116 receives input from the subscriber requesting one or more notifications when the identified people arrive at the meeting location. Under block 206, the subscriber can identify how he or she wishes to be notified, such as via SMS message, email message, voice call to the subscriber's wireless device (such as a pre-recorded audio message), instant messaging message, and so forth. The subscriber may also identify a particular device to receive the notification, such as a landline phone at the meeting location. The subscriber may also specify whether one or more meeting participants are to receive one or more similar notifications. Further, the subscriber can specify a range or radius from the meeting location at which to provide the notification. For example, rather than receive notification when one of the invitees is less than one quarter mile from the meeting location (which may be a default), the subscriber may request that the system provide notification when an invitee is within five miles of the meeting location.

Further, the system may provide notification based on initiation from the subscriber. For example, the subscriber may have identified one or more friends under block 202 to meet at a restaurant identified under block 204. On the way over to the restaurant, the subscriber may wish to see whether any of his friends have arrived. The subscriber sends a request message via the mobile unit 102 to the location server 116 to determine if any of the invitees are at the restaurant. The server, in response, may send one or more text messages, such as “no one has arrived yet,” or “Joe and Mary have arrived.”

The subscriber can be notified by either a push or pull methodology. In the “push” method, the network will automatically push arrival notifications to the subscriber's device. For example, a subscriber sends a meeting invitation from his cell phone to several friends. The subscriber indicates that he wishes to be notified of when his friends arrive at the meeting spot. The network would monitor the location of his friends who accept the invitation (via monitoring the location of their mobile devices), and as they arrive at the meeting spot, automatically send updates to the subscriber's cell phone. Alternatively, attendee updates could be sent by a “pull” method in which the subscriber's mobile device must request updated information. The network monitors the arrival of the invitees but only notifies the subscriber in response to a request for an update. For example, using the pull notification method, the subscriber's mobile device might request a status update from the network every five minutes. When the status request is received by the network, the network will respond by sending updated information to a predetermined recipient. The predetermined recipient could be the subscriber's cell phone, email account, meeting software (e.g., Microsoft Outlook), or any other suitable device or software application.

In another embodiment, the system can provide Estimated Time of Arrival (ETA) notifications. By monitoring the location of invitees, the system can provide an approximate time by which the invitee should arrive at the meeting location. This ETA could be calculated from historical knowledge (e.g., how long did it take others to get from the invitee's current location to the final destination?), current conditions (e.g., is it rush hour? is there a sporting event nearby that might affect traffic?), the invitee's average speed, etc. The system might obtain relevant traffic information from traffic monitoring systems and historical databases and adjust the ETA accordingly.

In addition to providing an ETA, the system could also notify the subscriber when it is time for the subscriber to leave for the meeting. For example, if the subscriber invites a friend to meet for lunch, the system could send an ETA message which says “Your friend will arrive at the restaurant in 20 minutes, you need to leave in 10 minutes to arrive at the same time as your friend.” The system may follow-up with a reminder in ten minutes which says, in effect, “You need to leave now to arrive at the restaurant at the same time as your friend.”

In block 208, the location server 116 coordinates the meeting by sending messages to the one or more people to notify them of the meeting request, to receive and forward RSVPs back to the subscriber, and so forth. The system can provide information to the subscriber or invitees, such as directions, a map, and so forth, as described in the above application. In block 210, the location server 116 identifies the location of the subscriber and invitees. Details regarding coordinating the meeting and identifying locations of wireless devices are found in the above application. In block 212, the location server 116 determines whether the subscriber or one of the meeting invitees are within the predetermined radius of the meeting location.

If no one is within the predetermined radius, then the routine loops back to block 210. Otherwise, if someone is within the radius, then in block 214, the location server 116 provides one or more notifications to the subscriber or invitees as previously designated under block 206. Each notification may also include additional information, such as the identity of the invitee, the time of day, ETA, and so forth. In block 216, the location server 116 determines whether any other invitees have yet to arrive at the meeting location. If so, the routine loops back to block 210; otherwise the routine ends.

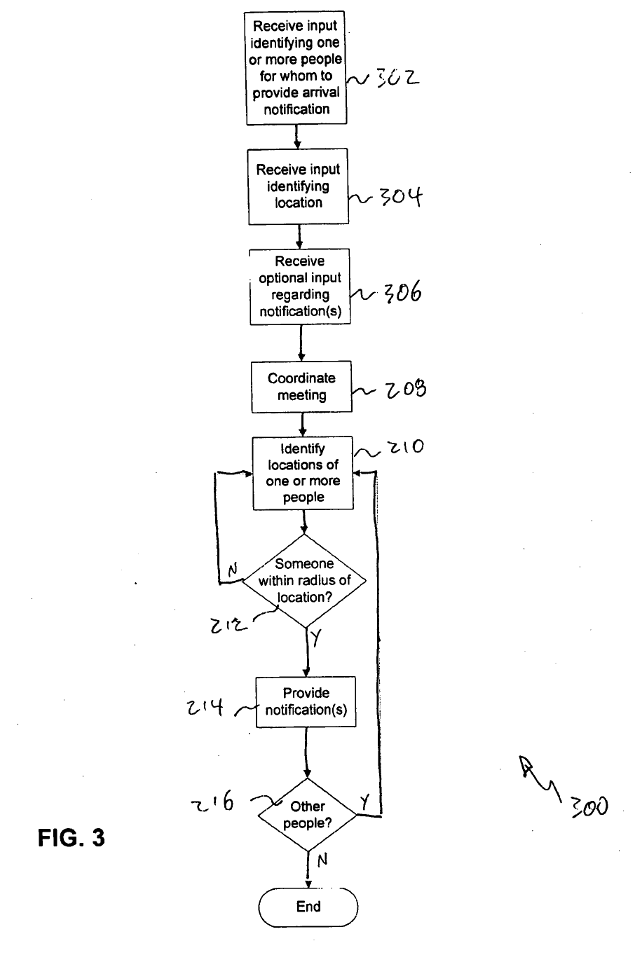

Many alternatives are possible. For example, FIG. 3 shows an alternative routine 300 that allows the subscriber to identify when one or more people arrive at a predetermined location. For example, the subscriber may wish to be notified when her son arrives at a predetermined location, such as a grocery store. Thus, in block 302, the location server 116 receives input from the subscriber identifying one or more people for whom the subscriber wishes to receive a notification when those people arrive at a predetermined destination. Again, the location server 116 may receive such input in any manner, as noted above.

Under block 304, the location server 116 receives input identifying the destination. If multiple people are identified in block 302, then likewise multiple destinations may be identified in block 304. Of course, combinations are possible, such as providing notification when multiple people arrive at two or more respective destinations. Alternatively, the system may provide a notification when the last of a group of people arrive at a single destination. Under some embodiments the system can allow invitees to be designated as “required” or “optional” for a meeting. Such systems could send notifications based on the designated class of invitee, e.g., “All the required attendees have arrived, some optional attendees have not arrived yet.”

In block 306, the location server 116 receives optional input regarding notifications. Such optional input may be where the subscriber identifies additional notifications beyond a default identification provided under block 302, such as two or more types of concurrent notification (both SMS and IM text notification messages), notifications at two or more radiuses (e.g., a first notification when the person is 5 miles away, and another notification when the person arrives at the destination), and so forth. Thereafter, the routine 300 performs under blocks 208 through 216 in a manner substantially similar to that noted above. In other words, whenever any one of the identified people arrives at the predetermined location, the location server 116 provides the predetermined notification to the subscriber.

In an alternative embodiment, the system can automatically record the attendees at a meeting. For example, a supervisor may use the system to request that all employees reporting to the supervisor gather in an auditorium for a meeting. Rather than write down the names of all attending employees, the system could automatically create a log of attending employees by monitoring their arrival at the auditorium. The attendee list could be sent to the supervisor (by email or any other suitable method) as a record of which employees attended the meeting.

Representative Mobile Units

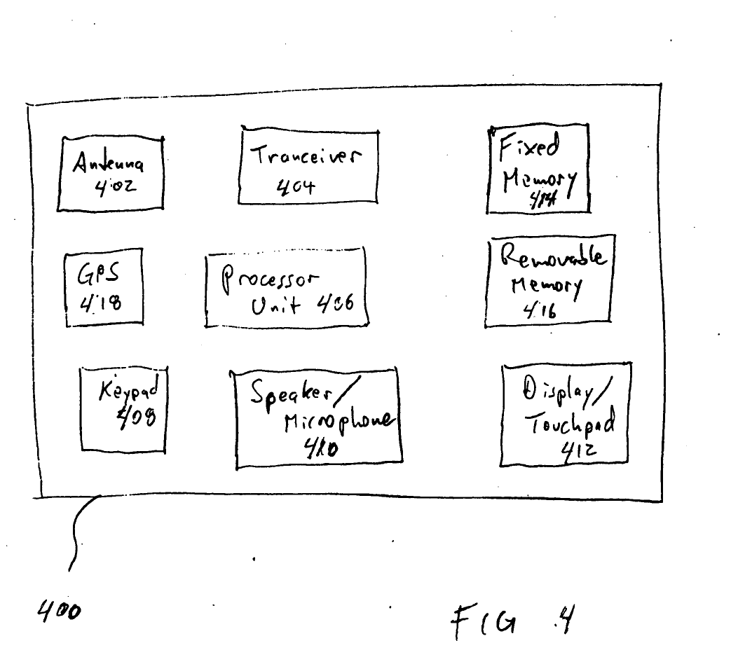

FIG. 4 shows a block diagram of a typical mobile communication device 400 such as a mobile station, wireless device, or the mobile unit 102. The mobile unit 400 has one or more internal or external antennas 402 for receiving and transmitting electromagnetic signals such as radio frequency signals. A transceiver 404 is connected to the antenna 402 and typically provides modulation and demodulation of the transmitted and received signals, respectively. One or more processor units 406 connected to the transceiver 404 may comprise a signal processor, microprocessor, ASIC, or other control and processing logic circuitry. The processor unit 406 may perform signal coding, data processing, input/output processing, power control, and other functions necessary for implementing a mobile communication device.

A user may provide input to the processor unit 406 via a keypad 408, speaker/microphone 410, or display/touchpad 412. In turn, the processor 408 may provide information to the user via the display/touchpad 412 or speaker/microphone 410. Additionally, the processor 406 may access information from, and store information in, a fixed memory 414 or a removable memory 416. The fixed memory 412 may consist of RAM, ROM, a hard disk, or other well-known memory storage technologies. The removable memory 416 may consist of Subscriber Identity Module (SIM) cards that are well known in GSM communication systems or other well-known memory storage technologies. The mobile communication device 400 may also include an optional GPS or other locational chipset or receiver 418 that provides latitude and longitude information about the mobile device's 400 current location.

In some embodiments of the invention, the mobile device 400 could store information, such as location information, in the removable memory 414 or non-removable memory 412. Such information could include, for example, the list of friends/invitees, POIs, or other data noted above (e.g., notification types, radius range, notification preferences). Indeed, any of the data structures or records described above may be stored in the removable memory 414. Upon receiving a command from an input device, such as a keystroke on the keypad 408, the processor unit 406 would retrieve or information from/to the removable memory 414 or non-removable memory 412.

If the mobile device 400 is equipped with the GPS receiver 418, the device may provide to the system latitude and longitude information about the mobile device's current location with a find request. The system may then skip certain steps and proceed directly to requesting notification(s) from the system.

Many alternatives are possible. For example, a dedicated button or switch may be provided on the mobile device 400 to permit the user to readily perform one or more functions described above. The processor 406 may execute program instructions that cause the mobile device 400 to periodically request updates of invitee's arrival status; display a menu of invitees and their arrival status to the user; transmit meeting invitations and information to the location server 116; cause the mobile device 400 to alert the user by audio or visual alarms; synchronize meeting invitations with calendar software; etc.

Conclusion

A service provider providing the functionality described above may derive revenue based on kilobyte traffic or usage. For example, each message sent, or corresponding reply, may generate revenue based on system usage. Alternatively, or additionally, the service provider may provide such functionality on a subscription basis. The service provider may provide premium content or features to users at rates higher than simple subscription fees for a data plan. For example, a user may receive notification when invitees arrive, while at higher rates a user could also determine if and when certain individuals arrived at a predetermined destination. The service provider may also obtain revenue on a per use basis. For example, each time the user receives a notification, the user may be charged a small, fixed fee. As another alternative, the service provider can derive revenue from compiling subscriber data into useful databases. For example, the system could record the various locations where subscribers meet for lunch and compile a ranked list of most popular lunch meeting locations. The service provider could sell this information to advertisers who wish to advertise at popular establishments.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” Additionally, the words “herein,” “above,” “below,” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list, and any combination of the items in the list.

The above Detailed Description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times. Where the context permits, words in the above Detailed Description using the singular or plural number may also include the plural or singular number respectively.

The teachings of the invention provided herein can be applied to other systems, not necessarily the cell phone system described herein. The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions, and concepts of the various references described above to provide yet further embodiments of the invention.

These and other changes can be made to the invention in light of the above Detailed Description. While the above description details certain embodiments of the invention and describes the best mode contemplated, no matter how detailed the above appears in text, the invention can be practiced in many ways. Details of the wireless location system may vary considerably in its implementation details, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention under the claims.

While certain aspects of the invention are presented below in certain claim forms, the inventors contemplate the various aspects of the invention in any number of claim forms. For example, while only one aspect of the invention is recited as embodied in a computer-readable medium, other aspects may likewise be embodied in a computer-readable medium. Accordingly, the inventors reserve the right to add additional claims after filing the application to pursue such additional claim forms for other aspects of the invention.

1. In a system for providing telecommunication services between multiple cell phones and multiple network access points, including a cell phone associated with a subscriber, an apparatus comprising:
at least one location server coupled among at least some of the network access points;
at least one database coupled with the location server, wherein the database includes a list of possible meeting invitees and location information regarding points of interest or meeting locations, and wherein the location server is configured to:
obtain a request from the subscriber's cell phone for a meeting between the subscriber and at least one invitee associated with a cell phone of the invitee based at least in part on the list of possible meeting invitees;
receive a specified meeting location from the subscriber's cell phone based at least in part on the location information regarding points of interest or meeting locations;
determine a geographic location of the invitee's cell phone; and
provide a notification message to at least the subscriber's cell phone when the invitee's cell phone is located at or near the specified meeting location.

2. The apparatus of claim 1 wherein the location server is further configured to:
obtain a request from the subscriber's cell phone for notification when a person associated with a cell phone of the person is at a destination;
receive a specified destination location from the subscriber's cell phone;
determine a geographic location of the person's cell phone; and
provide an arrival notification message to at least the subscriber's cell phone when the person's cell phone is located at or near the specified destination location.

3. The apparatus of claim 1 wherein the notification message is a short messaging service (SMS) message, an instant messaging (IM) message, a voice message or an electronic mail message.

4. The apparatus of claim 1 wherein the location server provides the notification message to the subscriber's and invitee's cell phones, and wherein the subscriber and invitee may provide a request to the location server for a notification message indicating an arrival status of all participants for the meeting.

5. In a system for providing wireless telecommunication services to mobile devices over a network, a method comprising:
obtaining a request from a subscriber associated with a first mobile device for notification when at least one person associated with a second mobile device arrives at or near a predetermined location;
automatically determining a location of at least the second mobile device; and
providing a notification message to the first mobile device, or to another telecommunications or computing device coupled to the network specified by the subscriber, when the second mobile device is at or near the predetermined location.

6. The method of claim 5 wherein the request is received from the first mobile device.

7. The method of claim 5 wherein the request is received from a user computer coupled to the network by way of the Internet.

8. The method of claim 5, further comprising:
automatically providing information to at least the first or second mobile device regarding a meeting location based at least in part on the determined location of the first or second mobile device.

9. The method of claim 5, further comprising:
receiving an RSVP message from the second mobile device; and
forwarding a signal related to the RSVP message to the first mobile device.

10. The method of claim 5, further comprising:
providing information regarding a meeting location, wherein the information includes a list of geographic points of interest.

11. The method of claim 5, further comprising:
receiving a radius parameter from the first mobile device; and
providing the notification message when the second mobile device is within the radius parameter.

12. The method of claim 5, further comprising:
receiving from the first mobile device a query for meeting invitees; and
providing to the first mobile device at least one electronic address based on the query.

13. The method of claim 5, further comprising:
receiving from the first mobile device a query for previous meeting invitees; and
providing to the first mobile device at least one previous meeting location based on the query.

14. The method of claim 5, further comprising:
receiving a request for a meeting near a current location of the first mobile device, near a current location of the second mobile device, or at an approximate equidistant midpoint between current locations of the first and second mobile devices.

15. The method of claim 5, further comprising:
obtaining a request from the first mobile device for a meeting with at least a user of a third mobile device; and
automatically coordinating an approximately concurrent meeting associated with the first, second and third mobile devices.

16. The method of claim 5, further comprising:
receiving a request from the first mobile for a meeting at the predetermined location with the person associated with the second mobile device.

17. The method of claim 5, further comprising:
providing a first notification message to the first mobile device when the second mobile device is within a predetermined radius of the meeting location, and
providing a second notification message to the first mobile device when the second mobile device is approximately at the meeting location.

18. The method of claim 5, further comprising:
obtaining locations of at least two mobile devices associated with at least two different individuals; and
providing to the first mobile device a list of the at two individuals with the obtained locations of the associated two mobile devices.

19. The method of claim 5 wherein the notification message is a short messaging service (SMS) message, an instant messaging (IM) message, a voice message or an electronic mail message.

20. The method of claim 5 wherein the notification message is provided to the subscriber's and the person's mobile devices, and wherein the subscriber and invitee may provide a request to the location server for a notification message indicating an arrival status of all participants for the meeting.

21. The method of claim 5 wherein the request is a meeting request between the subscriber and at least the person, and wherein the method includes receiving a request for a notification message indicating an arrival status of all participants for the meeting.

22. The method of claim 5 wherein the notification message indicates an identity and arrival time for the at least one person.

23. The method of claim 5, wherein near a predetermined location further comprises at least one selected from within a predetermined radius of the predetermined location and within a predetermined estimated time of arrival at the predetermined location.

24. The method of claim 5, further comprising providing a message indicating an estimated arrival time for the at least one person.

25. The method of claim 5, further comprising determining an estimated arrival time for the at least one person,
determining a location of the first mobile device and an estimated travel time to the predetermined location; and
notifying the subscriber when the subscriber should leave for the predetermined location or indicating the estimated travel time.

26. The method of claim 5 wherein attendees to a meeting at the predetermined location are classified into at least one of two classes, and wherein the method further comprises providing a notification indicating a number of each class of attendees near, or en route to, the predetermined location.

27. The method of claim 5, further comprising generating a list for the subscriber of all attendees arriving at the predetermined location.

28. The method of claim 5, further comprising generating a list of most popular meeting locations based on multiple meeting notification requests obtained from multiple subscribers.

29. A computer-readable medium whose contents cause at least a first mobile telecommunication device associated with a user to perform a method to receive location-based services from at least one telecommunications server, the method comprising:
at the first mobile telecommunications device, providing to the telecommunications server a request for notification when at least one person associated with a second mobile telecommunications device arrives at or within a predetermined radius of a predetermined location ; and
at the first mobile telecommunications device, receiving and providing to the user a notification message when the second mobile telecommunications device is at or within the predetermined radius of the predetermined location.

30. The computer-readable medium of claim 29 wherein the computer-readable medium is a memory of the first mobile telecommunications device.

31. The computer-readable medium of claim 29 wherein the computer-readable medium is a logical node in a computer network receiving the contents.

32. The computer-readable medium of claim 29 wherein the computer-readable medium is a computer-readable disk.

33. The computer-readable medium of claim 29 wherein the computer-readable medium is a data transmission medium carrying a generated data signal containing the contents.

34. The computer-readable medium of claim 29 wherein the computer-readable medium is a memory of a computer system.

35. In a system for providing wireless telecommunication services to mobile devices over a network, an apparatus comprising:
means for obtaining a request from a subscriber associated with a first mobile device for notification when at least one person associated with a second mobile device arrives at or within a predetermined radius of a predetermined location;
means for automatically obtaining location information associated with at least the second mobile device; and
means for providing a notification message to the first mobile device, or to another telecommunications or computing device coupled to the network and specified by the subscriber, when the second mobile device is near the predetermined location, or providing an estimated time of arrival message indicating when the second mobile device is estimated to be near the predetermined location.

36. The apparatus of claim 35, further comprising means for providing point of interest categories for meetings that include restaurants, coffee shops, bars/pubs or bookstores.

37. The apparatus of claim 35 wherein the request is obtained from the first mobile device and relates to a meeting between the subscriber and the person.

38. The apparatus of claim 35, further comprising:
means for receiving a radius parameter from the first mobile device; and
means for providing the notification message when the second mobile device is within the radius parameter.

39. The apparatus of claim 35, further comprising:
means for receiving a request from the first mobile for notification when two or more individuals associated with respective mobile devices arrive at the predetermined location.

40. The apparatus of claim 35 wherein the notification message is a short messaging service (SMS) message, an instant messaging (IM) message, a voice message, or an electronic mail message.

41. A wireless telecommunications apparatus for providing to a user location-based services within a wireless telecommunications network, the wireless telecommunications apparatus comprising:
a wireless transceiver;
at least one input device;
at least one output device; and
a processor coupled to the wireless transceiver, input device, and output device, wherein the processor is configured to:
operate within the wireless telecommunications network and to communicate with a location server;
provide to the location server a request for notification when at least one person associated with another wireless telecommunications apparatus arrives at, within a predetermined radius of, or near a predetermined location;
receive from the location server a notification message when the another wireless telecommunications apparatus is at, within the predetermined radius of, or near the predetermined location; and
provide to the user the notification message via the output device.

42. The wireless telecommunications apparatus of claim 41, further comprising memory, coupled to the processor, for a list of meeting invitees or meeting locations.

43. The wireless telecommunications apparatus of claim 41, further comprising location determining circuitry, coupled to the processor, for determining a geographical location of the wireless telecommunications apparatus.
